(19) United States
(12) Patent Application Publication
(10) Pub. No.: US 2009/0189926 A1
(43) Pub. Date: Jul. 30, 2009

(54) Tachograph for a Motor Vehicle

(76) Inventors: Klaus Hug, Oberndorf (DE); Herbert Kirner, Villingen-Schwenningen (DE); Benjamin Säger, Villingen-Schwenningen (DE); Harald Trampert, Villingen-Schwenningen (DE); Torsten Wahler, Bad Dürrheim (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/308,870

(22) PCT Filed: May 31, 2007
(86) PCT No.: PCT/EP2007/055305

§ 371 Date: Dec. 24, 2008

(30) Foreign Application Priority Data
Jun. 26, 2006 (DE) 10 2006 029 200.6

(51) Int. Cl. G01C 7/00

(52) U.S. Cl. 346/25

(57) ABSTRACT

A tachograph for a motor vehicle comprises a guide element for guiding a paper strip in relation to a printing group. The guide element requires no pretensioning means and is connected to the printing group via a carrier. As a result, the paper strip is reliably aligned in relation to the printing couple.

The invention relates to a tachograph for a motor vehicle having a receptacle for a paper strip which is wound on a paper reel, having a printing unit for outputting data in accurately provided positions with respect to a zero line of a region to be printed, which zero line extends longitudinally over the paper strip in the provided direction of movement, and having a drive device for driving the paper strip.

Tachographs for motor vehicles, in which the data are printed out via the printing unit, require as accurate as possible an orientation of the paper strip with respect to the printing unit, since the data, for example a graphic illustration of the driving speed of the motor vehicle plotted against time, have to be transferred in the provided positions with respect to the zero line. Therefore, during insertion, the new paper reel has to be adjusted with respect to the region to be printed.

However, it is disadvantageous in the known tachograph that tolerances can occur between the printing unit and the visible zero line of the region to be printed of the paper reel, with the result that the position of the data with respect to the zero line is not ensured reliably. Tolerances of this type can be produced, for example, as a result of an oblique position of the drive of the paper reel.

The invention is based on the problem of designing a tachograph of the type mentioned in the introduction, in such a way that it makes a particularly reliable assignment possible of the data which are output by the printing unit relative to the zero line on the paper strip and is of particularly simple construction.

According to the invention, this problem is solved by virtue of the fact that the printing unit is assigned a guide element, and by the fact that the guide element is configured for orienting the paper strip with respect to the printing unit without further prestressing means.

As a result of this design, the paper strip is oriented reliably by the guide element. The assignment of the guide element to the printing unit can be brought about, for example, by a holder of the printing unit and the guide element being of single-part design. The guide element therefore makes a particularly reliable orientation possible of the paper strip and therefore of the region to be printed with respect to the printing unit. Since the guide element does not have any further prestressing means, a distortion of the paper strip is reliably avoided. Furthermore, the avoidance of the prestressing means leads to a particularly simple construction of the tachograph according to the invention.

Tolerances in the assignment of the position of the guide element with respect to the printing unit can be kept particularly low according to another advantageous development of the invention if the printing unit and the guide element are arranged on a common carrier.

According to one advantageous development of the invention, a contribution is made to further increasing the accuracy of the printout if the receptacle is wider than the paper reel. As a result of this design, the paper reel lies in the receptacle such that it can move in the direction of its axis, with the result that the orientation of the paper strip with respect to the printing unit is fixed exclusively by the guide element.

According to another advantageous development of the invention, the guide element is designed particularly simply in structural terms if the guide element has two U-shaped guide parts which reach around the lateral edges of the paper strip. A contribution is made to the further simplification of the construction of the tachograph according to the invention if the two U-shaped guide parts are produced as a single-part guide profile.

According to another advantageous development of the invention, a further possibility of guiding the paper strip reliably comprises the guide element having an adjusting wheel which penetrates with projections into a row of cutouts of the paper strip.

According to another advantageous development of the invention, particularly precise positioning of the zero line with respect to the printing unit results if the adjusting wheel is arranged on that lateral boundary of the paper strip which comes closest to the zero line.

According to another advantageous development of the invention, a contribution is made to further increasing the accuracy of the printout of the data on the paper strip if two adjusting wheels are arranged on both longitudinal sides of the paper strip and have projections which penetrate in each case into cutouts of the paper strip. A further advantage of this design comprises the fact that, as a result, the paper strip can be tensioned on the printing unit by the adjusting wheels, which contributes to a further increase in the accuracy of the printout.

The invention permits numerous embodiments. In order to clarify its basic principle further, two of them will be described in the following text and are shown in the drawing, in which:

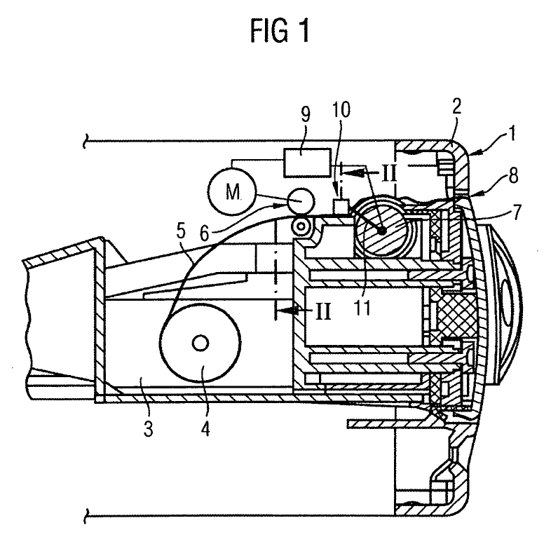

FIG. 1 shows a longitudinal section through a tachograph according to the invention,

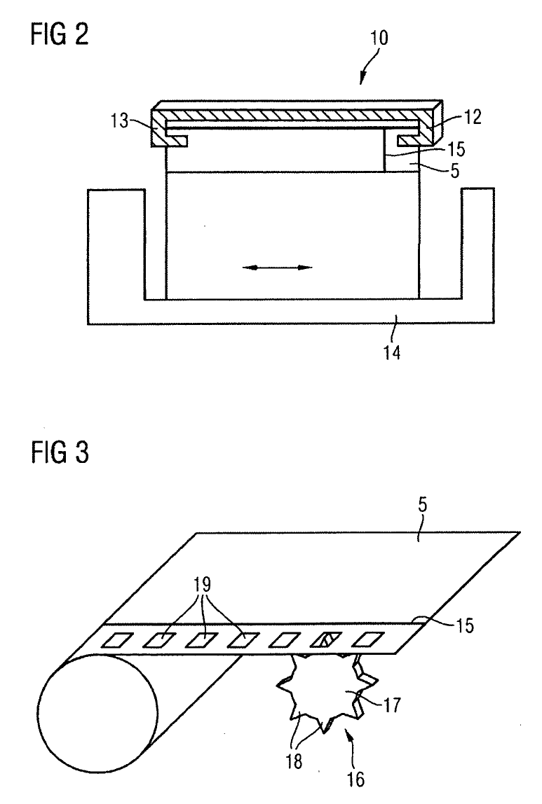

FIG. 2 shows an offset sectional illustration in enlarged form through the tachograph from FIG. 1 along the line II-II, and

FIG. 3 shows a side view of a further embodiment of the tachograph in the region of a guide element.

FIG. 1 shows a tachograph 1 for a motor vehicle in longitudinal section with a front panel 2 and with a printer drawer 3 for receiving a paper reel 4. A paper strip 5 is wound on the paper reel 4, which paper strip 5 is transported by means of a drive device 6 to a printing unit 7 and from there to a gap 8 in the front panel 2. The printing unit 7 and the drive device 6 are connected to an electronic control unit 9. The paper strip 5 which is printed by the printing unit 7 is discharged through the gap 8 in the front panel 2 and can be torn off. Furthermore, the electronic control unit 9 can be provided with sensors (not shown) which sense markings (likewise not shown) on the paper strip 5. Furthermore, the paper strip 5 is guided by a guide element 10 immediately in front of the printing unit 7. The guide element 10 and the printing unit 7 have a common carrier 11.

FIG. 2 shows a sectional illustration through the tachograph from FIG. 1 along the line II-II. It can be seen here that the guide element 10 has two U-shaped guide parts 12, 13 which reach around in each case one edge of the paper strip 5. The two U-shaped guide parts 12, 13 are designed in one piece as a common guide profile. A receptacle 14 for the paper reel 4, which receptacle 14 is arranged in the printer drawer from FIG. 1, is designed to be wider than the paper reel 4. As a result, the paper reel 4 can orient itself automatically on the guide element 10. In addition, FIG. 2 diagrammatically shows a zero line 15 on the paper strip 5, with respect to which zero line 15 the printout of the printing unit 7 is to be carried out.

FIG. 3 shows a further embodiment of the tachograph, in which a guide element 16 has an adjusting wheel 17 with a row of projections 18. The projections 18 penetrate into a row of cutouts 19 which are arranged on the paper strip 5. The adjusting wheel 17 is arranged only on one side of the paper strip 5 close to the printed zero line 15. In one embodiment which is not shown, a further adjusting wheel 17 can be arranged close to the opposite edge of the paper strip 5.

1-8. (canceled)

9. A tachograph for a motor vehicle coupling:
a receptacle configured to receive a paper reel upon which a paper strip is wound;
a printing unit configured to accurately output data with respect to zero line in an area of the paper strip, the zero line extending longitudinally along the paper strip;
a guide element configured to orient the area of the paper strip to the printing unit without prestressing means.

10. The tachograph according to claim 9, wherein the printing unit and the guide element are arranged on a common carrier.

11. The tachograph according to claim 9, wherein the receptacle is wider than the paper reel.

12. The tachograph according to claim 9, wherein the guide element comprises two U-shaped guide parts that reach around respective lateral edges of the paper strip.

13. The tachograph according to claim 12, wherein the two U-shaped guide parts are produced as a portion of single-part guide profile.

14. The tachograph according to claim 9, wherein the guide element comprises an adjusting wheel having projections that penetrate into a row of cutouts of the paper strip.

15. The tachograph according to claim 14, wherein the adjusting wheel is arranged on a lateral boundary of the paper strip closest to the zero line.

16. The tachograph according to claim 9, further comprising two adjusting wheels arranged on both longitudinal sides of the paper strip and each have projections which penetrate into respective cutouts of the paper strip.

17. The tachograph according to claim 12, wherein the guide element further comprises an adjusting wheel having projections that penetrate into a row of cutouts of the paper strip.

18. The tachograph according to claim 12, further comprising two adjusting wheels arranged on both longitudinal sides of the paper strip and each have projections which penetrate into respective cutouts of the paper strip.
